(19) United States
(12) Patent Application Publication
(10) Pub. No.: US 2012/0227732 A1
(43) Pub. Date: Sep. 13, 2012

(54) Grill Device

(76) Inventors: Jan-Nan Chen, Taichung City (TW); Red Gu, Taichung City (TW)

(21) Appl. No.: 13/216,293

(22) Filed: Aug. 24, 2011

(30) Foreign Application Priority Data
Mar. 10, 2011 (TW) 100108186

(51) Int. Cl. A47J 37/07

(52) U.S. Cl. 126/9 R; 126/39 B

(57) ABSTRACT

A grill device includes a chamber, a lid, and first and second legs. The first leg is pivotally connected to the chamber. The second leg is pivotally connected to the first leg. The grill device has two standing configurations on a surface. The grill device configured in a first standing configuration includes the first leg including an engaging section disengaged from a lock protruded from the lid and capable of abutting against the surface and includes the second leg including an abutting section capable of abutting against the surface and a hooking section engaged with a catch protruded from the chamber. The grill device configured in the second standing configuration includes the first leg including the engaging section engaged with the lock and includes the second leg including the abutting section capable of abutting against the surface and the hooking section disengaged from the catch and engaged with the lock.

### BACKGROUND OF THE INVENTION

1. Field of the Invention

The present invention relates to a grill device.

2. Description of the Related Art

U.S. Pat. No. 4,955,358 shows a combination of a grill device and a trolley. Although the trolley can facilitate transportation of the grill device, there are some places that the trolley can not go. Storage of the grill device and the trolley is difficult, too. Additionally, TW Patent No. 444578 shows a grill device including a chamber and two legs used for supporting the chamber on a surface. The grill device can be folded into a more compact configuration for transportation, with the two legs positioned in a collapsed position. As a result, a user can easily carry the grill device. Unfortunately, there is encountered a problem that the legs are liable to release from the collapsed position.

The present invention is, therefore, intended to obviate or at least alleviate the problems encountered in the prior art.

### SUMMARY OF THE INVENTION

According to the present invention, a grill device includes a chamber, a burner, a lid, and first and second legs. The chamber includes an opening and a cavity defined therein. The opening is disposed above the cavity. The burner is disposed in cavity. The lid is pivotally connected to the chamber. The lid is positionable in first and second pivotal positions. The opening and the cavity are not exposed when the lid is in the first position. Furthermore, the opening and the cavity are capped by the lid when the lid is in the first position. The opening and the cavity are exposed when the lid is in the second position. Furthermore, the opening and the cavity are not caped by the lid when the lid is in the second position. The first leg is pivotally connected to the chamber. The second leg is pivotally connected to the first leg.

Furthermore, the grill device has two standing configurations on a surface. The grill device configured in a first standing configuration includes the first leg including an engaging section defined thereon disengaged from a lock protruded from the lid and capable of abutting against the surface and includes the second leg including an abutting section defined thereon capable of abutting against the surface and a hooking section defined thereon engaged with a catch protruded from the chamber and includes the first and second legs having an obtuse included angle θ1 defined therebetween and determining a distance between the engaging and abutting sections. The grill device configured in the second standing configuration includes the first leg including the engaging section engaged with the lock and includes the second leg including the abutting section capable of abutting against the surface and the hooking section disengaged from the catch and engaged with the lock and includes first and second axes having an acute included angle defined therebetween and determining an angle that the chamber and the lid tilt with respect to the second leg, with the first axis defining a direction the second leg is oriented, with the second axis defining a direction the chamber and the lid are oriented. Further, a center of gravity of the grill device disposed between the first and second axes.

It is an object of the present invention to provide an easy-to-carry grill device.

It is also an object of the present invention to allow a person to safely carry the grill device.

It is a further object of the present invention to provide a grill device capable of configured in two standing configurations on a surface.

It is a further object of the present invention to provide a grill device capable of standing on a surface stably.

It is another object of the present invention to provide a grill device that can be folded in a compact configuration for smaller stowage size.

It is yet another object of the present invention to allow a user to grasp the first and second legs when the grill is positioned in the second standing configuration.

### BRIEF DESCRIPTION OF THE DRAWINGS

FIG. 1 is a perspective view of a grill device in accordance with the present invention and shows the grill device configured in a first configuration.

FIG. 2 is a perspective view of the grill device of FIG. 1 and shows the grill device configured in a second configuration.

FIG. 3 is an exploded perspective view of the grill device of FIG. 1.

FIG. 4 is a side view of the grill device of FIG. 1.

FIG. 5 is a top view of the grill device of FIG. 1.

FIG. 6 is a cross-sectional view of the grill device of FIG. 1, showing two pivots utilized to pivotally interconnect first and second legs of the grill device.

FIG. 7 is a partial, cross-sectional view of the grill device of FIG. 1.

FIG. 8 is another perspective view of the grill device of FIG. 1, with the grill device configured in the second configuration.

FIG. 9 is a cross-sectional view of the grill device of FIG. 1, with the grill device configured in the second configuration.

FIG. 10 is a side view of the grill device of FIG. 1, with the grill device configured in the second configuration, with the grill device including a lock positioned in a position not holding the first and second legs.

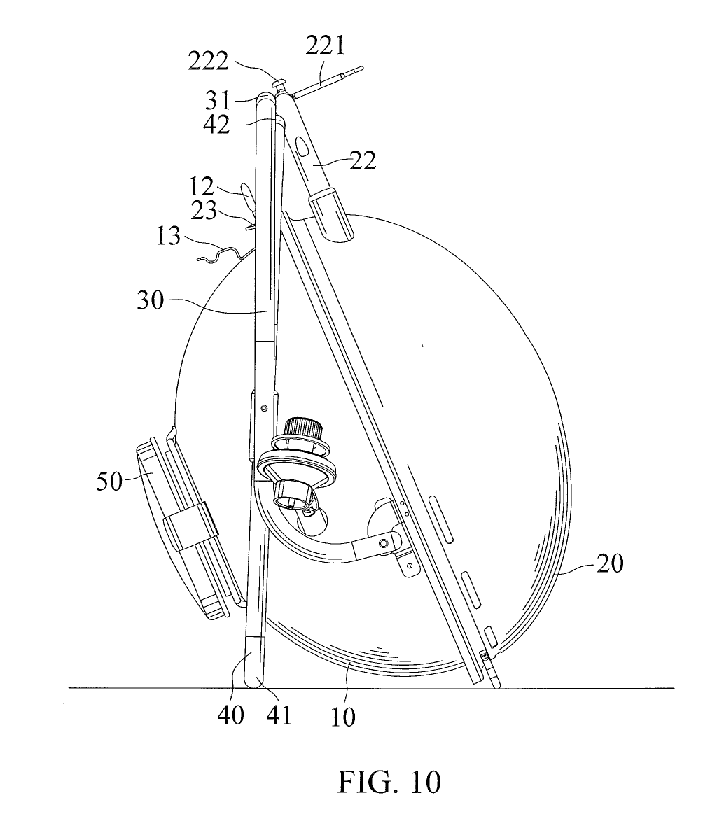

FIG. 11 is an extended side view of FIG. 10, with the lock not holding the first and second legs, with the grill device including a catch disengaged from the second leg, with first and second legs having a relative position different than that of FIG. 10, with the grill device standing on a surface including the first leg not abutting against the surface.

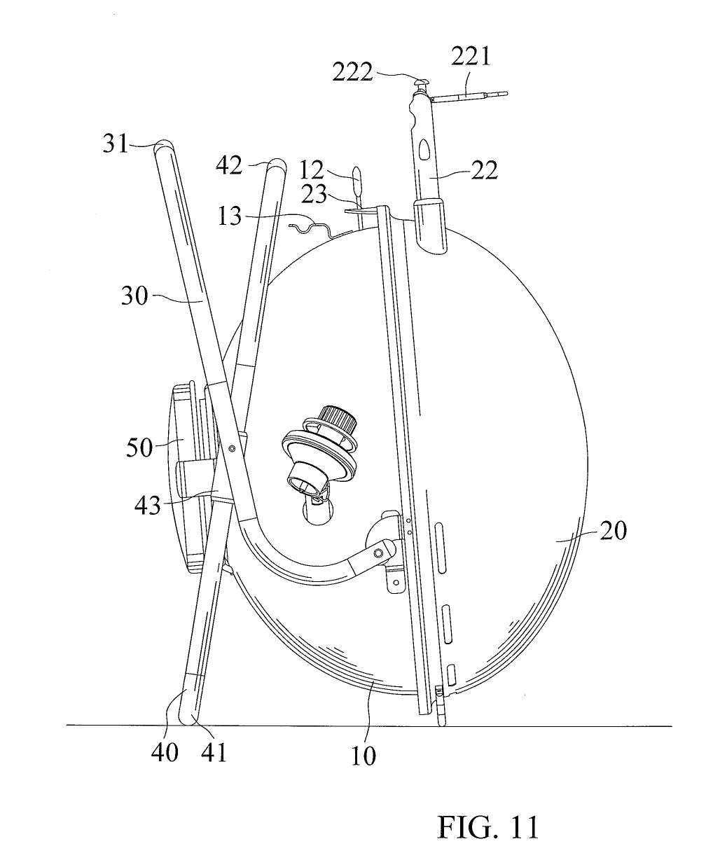

FIG. 12 is an extended side view of FIG. 11, with the lock not holding the first and second legs, with the catch engaged with the second leg with first and second legs having a relative position different than that of FIG. 11, with the first leg not abutting against the surface.

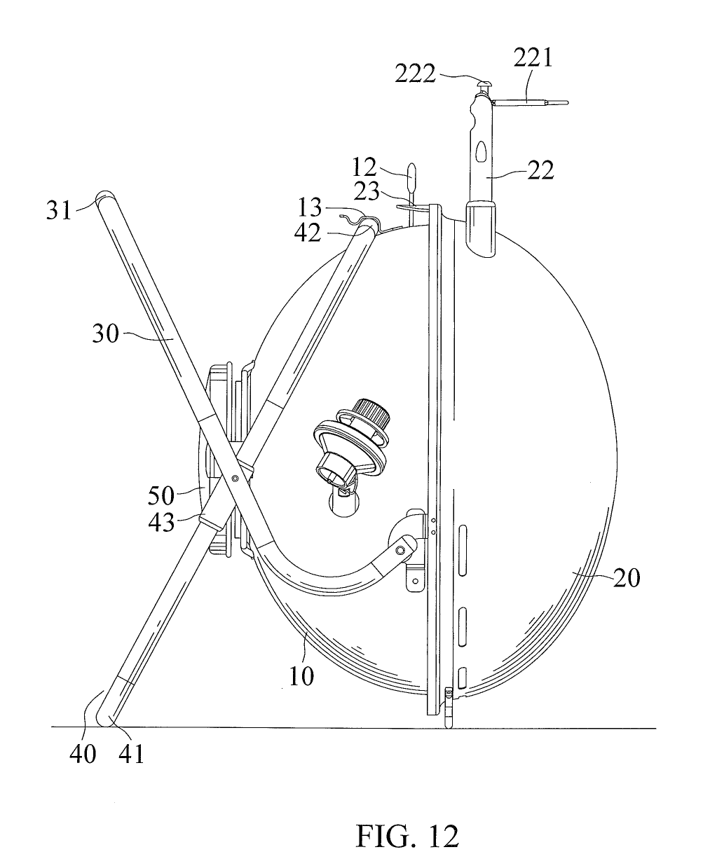

FIG. 13 is another side view of the grill device of FIG. 1, with the grill device including a chamber and a lid capping the chamber.

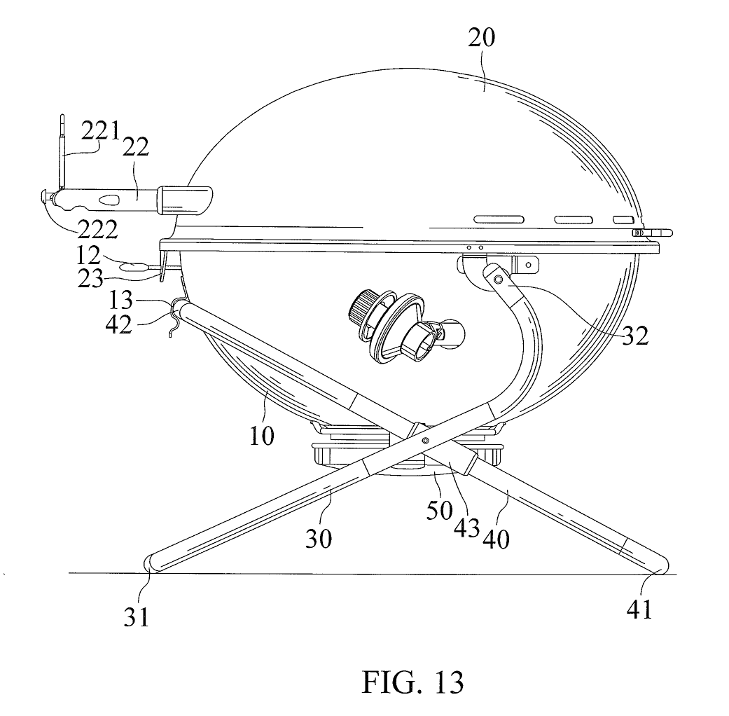

### DETAILED DESCRIPTION OF THE PREFERRED EMBODIMENT

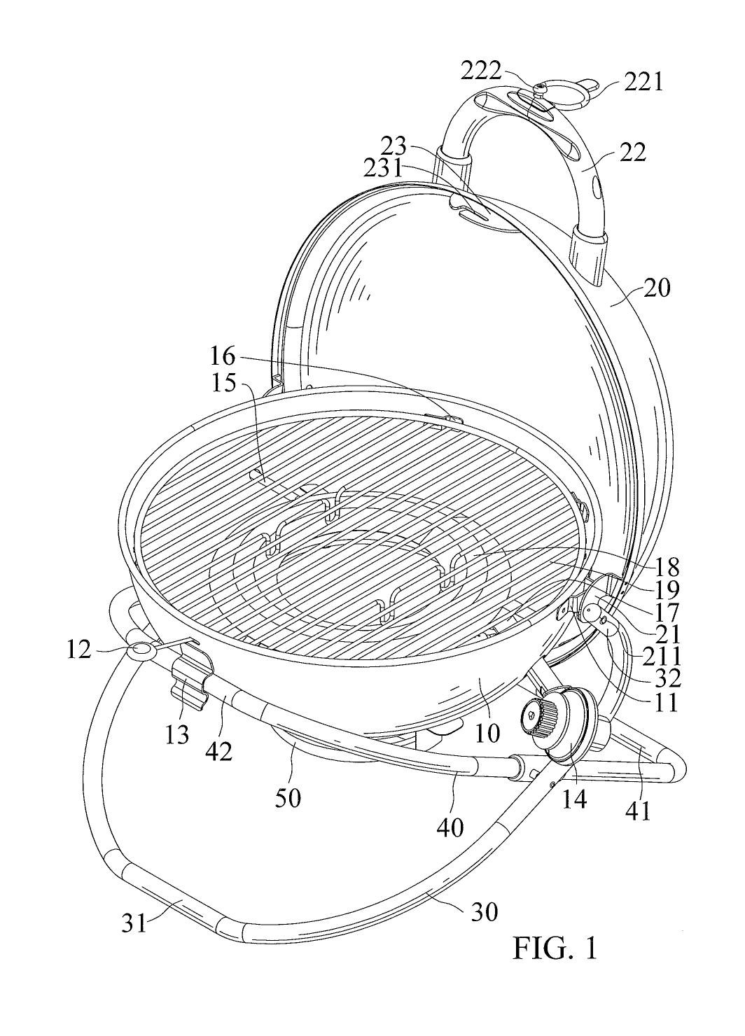

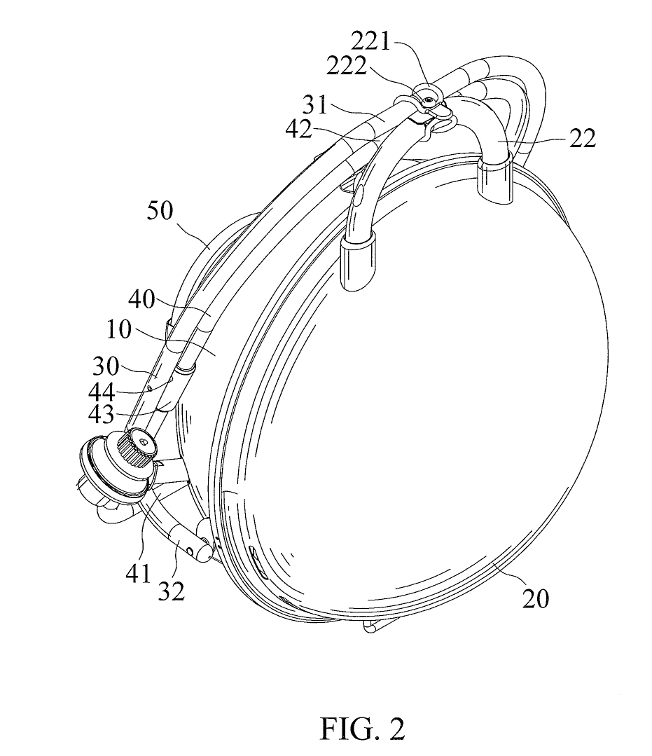

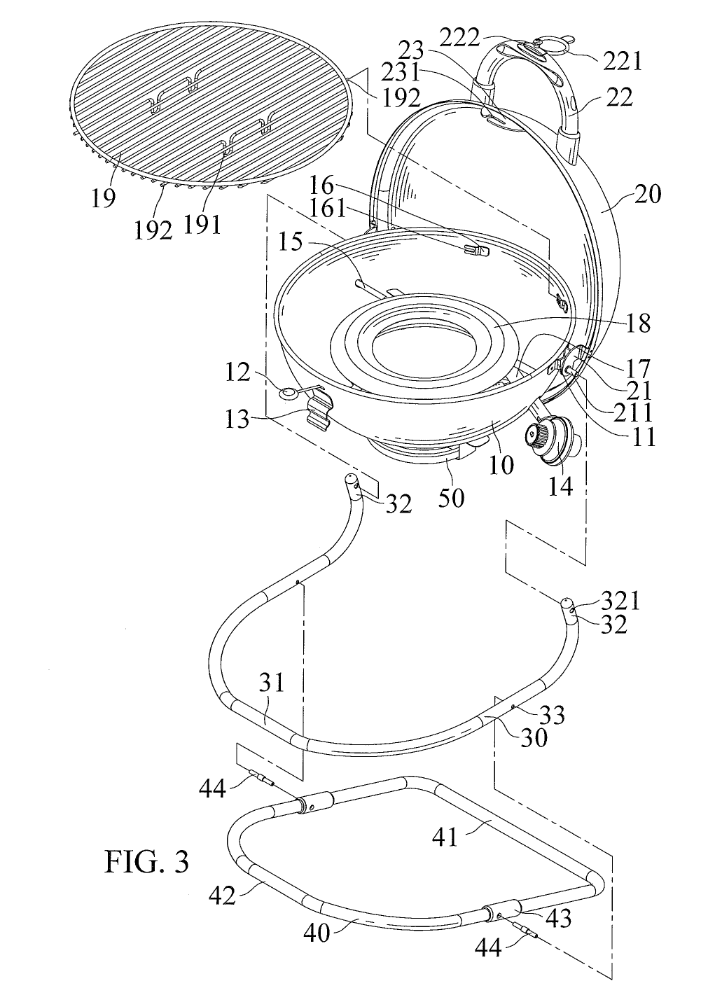

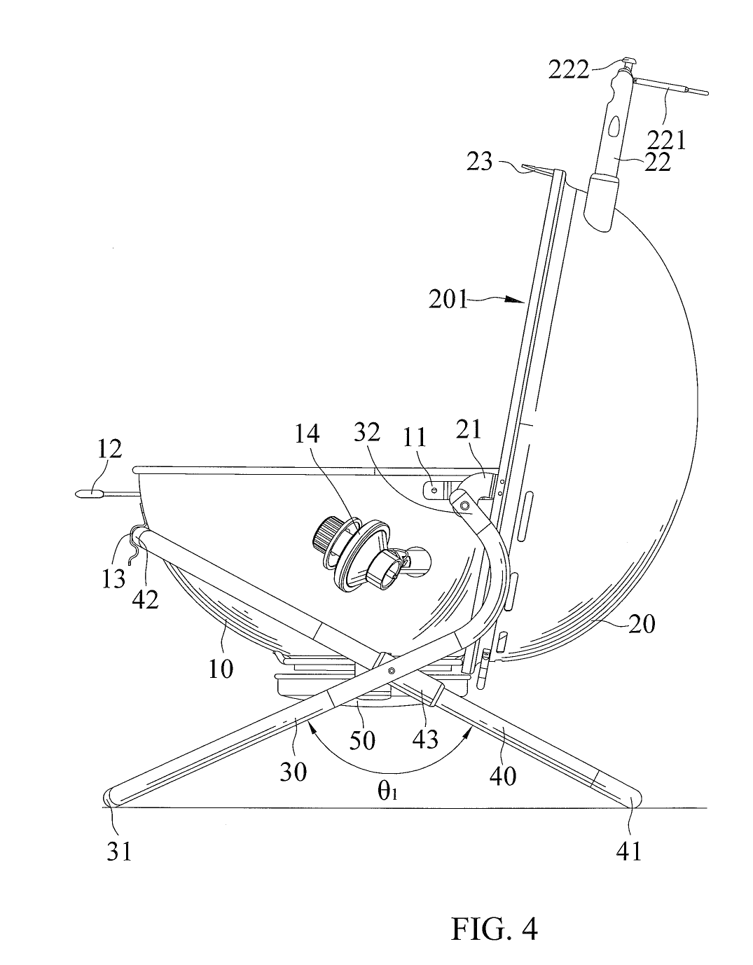

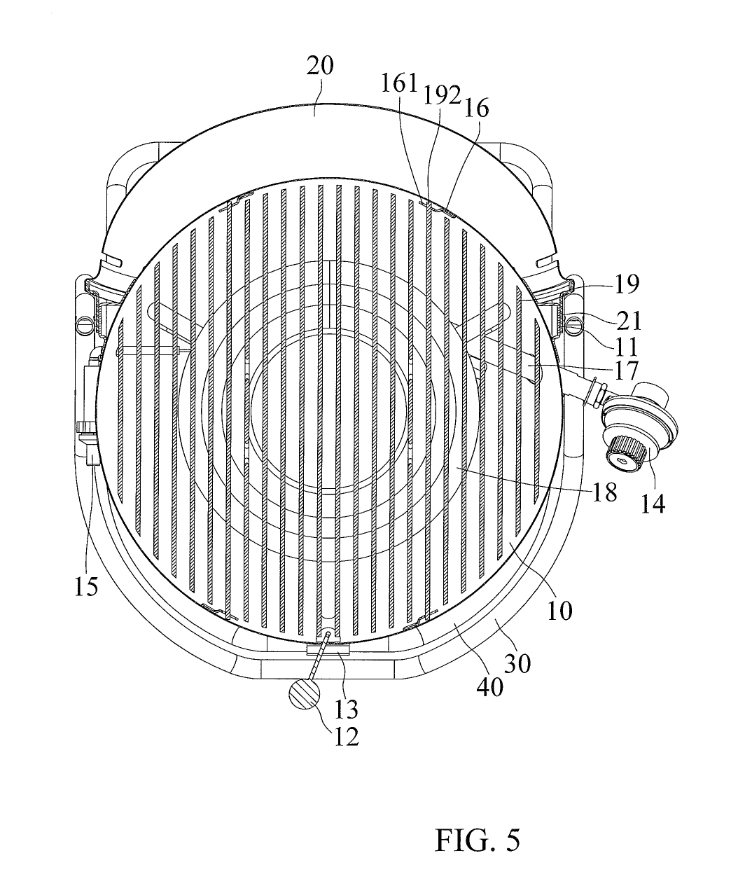

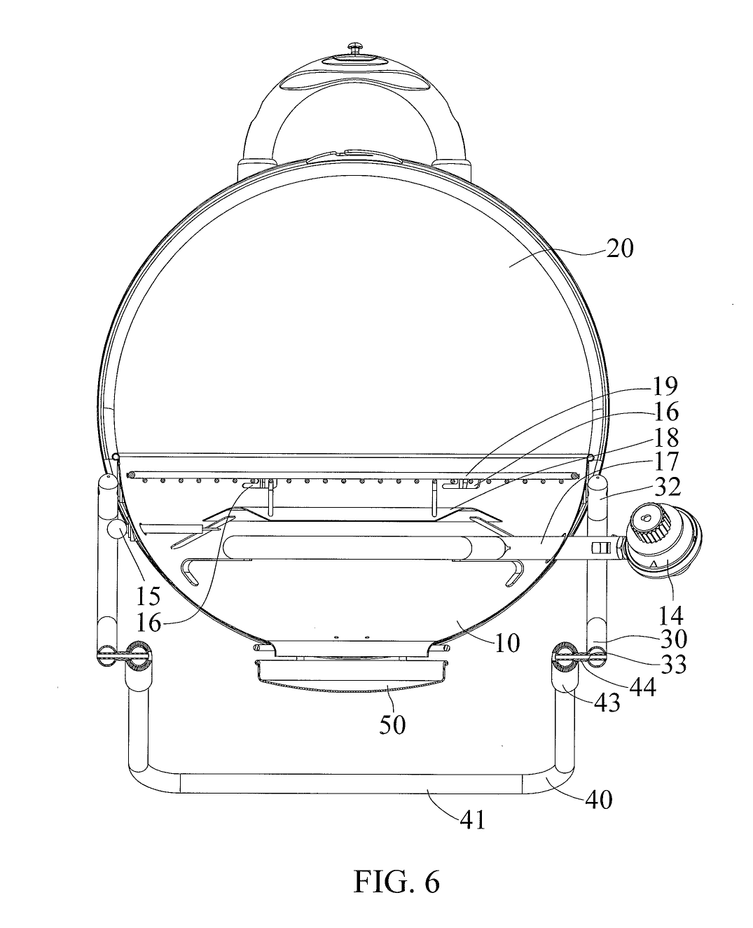

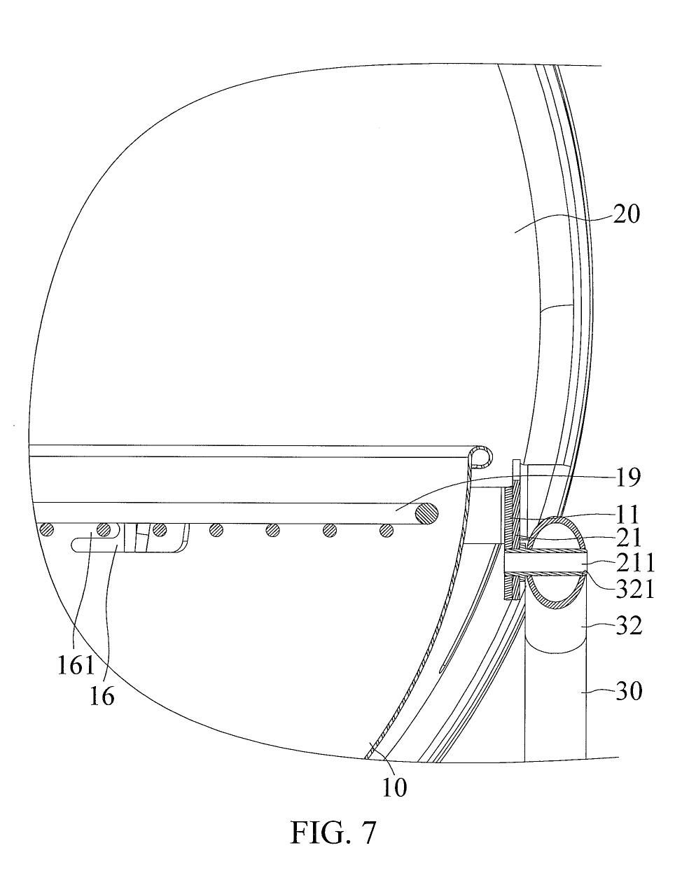

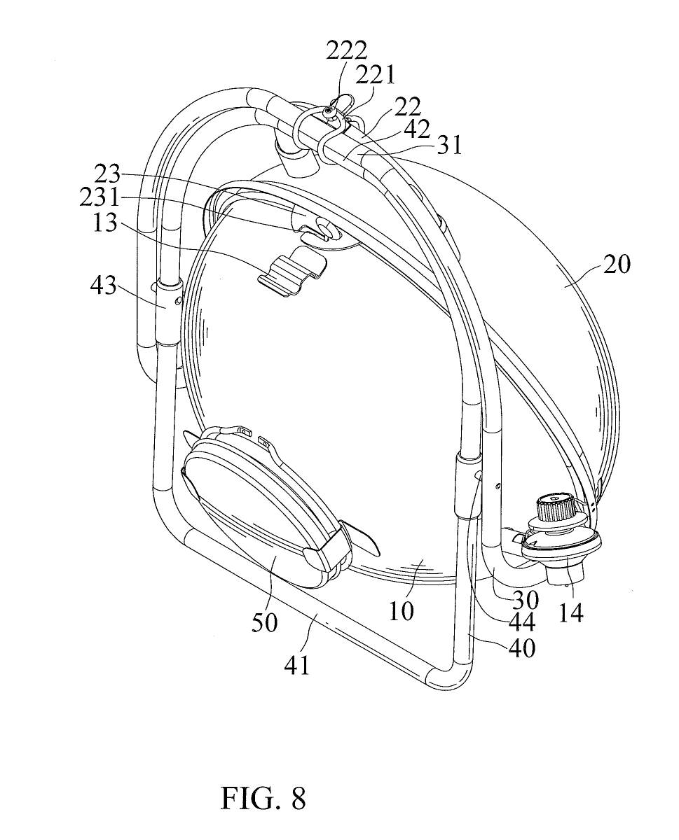

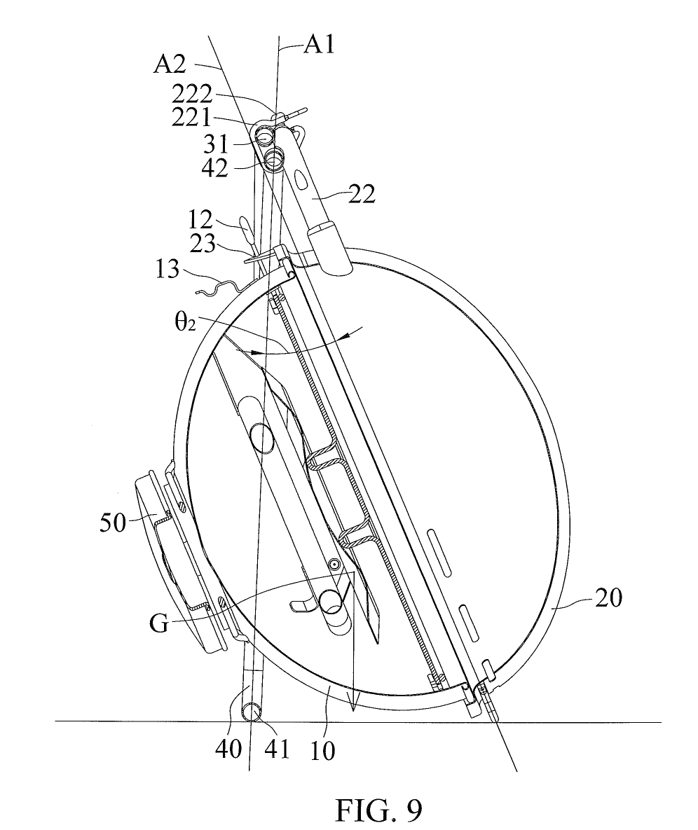

FIGS. 1 through 9 show a grill device including a chamber 10, a burner 18, a lid 20, and first and second legs 30 and 40.

The chamber 10 includes an opening and a cavity defined therein. The opening is disposed above the cavity. The chamber 10 includes two first lugs 11 protruded therefrom. The burner 18 is disposed in cavity. Further, a latch 12 is protruded from one of the chamber 10. Further, a hook 23 is protruded from the lid 23 and includes a notch 231 defined therein. The latch 12 is selectively engagable in the notch 231.

The lid 20 is pivotally connected to the chamber 10. The lid 20 is positionable in first and second pivotal positions. The opening and the cavity are not exposed when the lid 20 is in the first position. Furthermore, the opening and the cavity are capped by the lid 20 when the lid 20 is in the first position. Additionally, the lid 20 positioned in the first position includes the latch 12 engaged in the notch 231. The opening and the cavity are exposed when the lid 20 is in the second position. Furthermore, the opening and the cavity are not caped by the lid 20 when the lid 20 is in the second position. The lid 20 includes two second lugs 21 protruded therefrom. One of the two lugs 11 and one of the two lugs 21 are interconnected pivotally and include one of two pintles 211 engaged therebetween. Each lug 11 is pivotal about the pintle 211 engaged therewith. Likewise, each lug pivotal 21 about the pintle 211 engaged therewith. The lid 20 also includes a handle 22 protruded therefrom and capable of being grasped. The handle 22 includes the lock 221 disposed thereon. The handle 22 further includes a holding element 222 protruded therefrom.

The first leg 30 is pivotally connected to the chamber 10. The first leg 30 includes first and second distal ends and extends from the first distal end to the second distal end in a first direction. The second leg 40 is pivotally connected to the first leg 30. The second leg 40 includes first and second distal ends and extends from the first distal end to the second distal end in a second direction, which intercrosses the first direction. Additionally, the first leg 30 includes the first distal end including an engaging section 31 defined thereon and the second distal end including a connecting section 32 defined thereon. Also, the first leg 30 includes two joining sections 33 defined thereon and located between the first and second distal ends. Each of joining sections 33 is in the form of an aperture. The first leg 30 has a U-shape configuration and includes the connecting section 32 defining two connecting ends. Each connecting end includes one of the two pintles 211 engaged therewith. Each connecting end includes an orifice 321 defined therein, and the pintle 211 engaged therewith includes an end received in the orifice 321. Additionally, the second leg 40 includes the first distal end including an abutting section 41 defined thereon and the second distal end including a hooking section 42 defined thereon. Also, the second leg 40 includes two joining sections 43 defined thereon and located between the first and second distal ends. Each of joining sections 43 is in the form of an aperture. The second leg 40 has a configuration including two lateral extensions separated from each other and extending from the abutting section 41 to the hooking section 42. The abutting section 41, the hooking section 42 and the two lateral extensions extend in a same plane. Further, two pivots 44 pivotally engage the first and second legs 30 and 40. The two joining sections 33 are pivotable about the pivots 44. Likewise, the second joining sections 43 are pivotal about the pivots 44.

Moreover, the grill device has two standing configurations on a surface. The grill device configured in a first standing configuration includes the first leg 30 including the engaging section 31 defined thereon disengaged from the lock 221 protruded from the lid 20 and capable of abutting against the surface and includes the second leg 40 including the abutting section 41 defined thereon capable of abutting against the surface and the hooking section 42 defined thereon engaged with a catch 13 protruded from the chamber 10 and includes the first and second legs having an obtuse included angle θ1 defined therebetween and determining a distance between the engaging and abutting sections. The grill device configured in the second standing configuration includes the first leg 30 including the engaging section 31 engaged with the lock 221 and includes the second leg 40 including the abutting section 41 capable of abutting against the surface and the hooking section 42 disengaged from the catch 13 and engaged with the lock 221 and includes first and second axes having an acute included angle defined therebetween and determining an angle that the chamber and the lid tilt with respect to the second leg, with the first axis defining a direction the second leg is oriented, with the second axis defining a direction the chamber and the lid are oriented. Further, a center of gravity of the grill device disposed between the first and second axes.

Furthermore, the grill device configured in the second standing configuration includes the lock 221 including a length holding the handle 22, the engaging section 31 of the first leg 30, and the hooking section 42 of the second leg 40 together and includes an end fastened to the holding element 222. A user is able to grasp the first and second legs 30 and 40 when the grill is positioned in the second standing configuration. Likewise, the can is able to grasp the handle 22 when the grill is positioned in the second standing configuration. As a result, the aforementioned problem in respect of the TW Patent No. 444578 is resolved.

Moreover, the grill device includes a gas adaptor 14, a burner igniter 15, a gas pipe 17, a cooking plate 19 and a drip pan 50. The gas adaptor 14 is protruded from the chamber 10 and disposed outside the cavity of the chamber 10. The gas pipe 17 fludially connects the gas adaptor 14 to the burner 18. The grill device is capable of engaging with a gas supply, with the grill device engaged with the gas supply including the gas adaptor 14 engaging with the gas supply. The burner igniter 15 is disposed in the cavity of the chamber 10. The cooking plate 19 forms a cooking surface is capable of being positioned above the burner 18. The cooking plate 19 has a configuration including a plurality of rods collectively form the cooking surface and at least one of the rods including a foot 191 protruded therefrom and having a depth to the cooking surface. One of the plurality of rods includes a distal end including a joining end 192 defined thereon. The chamber 10 includes a bracket 16 disposed in the cavity and including a slot 161 defined therein. The cooking plate 19 is positioned above the burner 18 and includes the joining end engaged in the slot 161. The drip pan 50 is engaged with the chamber 10 and disposed outside the cavity of the chamber 10.

While the specific embodiment has been illustrated and described, numerous modifications come to mind without significantly departing from the spirit of invention, and the scope of invention is only limited by the scope of the accompanying claims.

What is claimed is:

1. A grill device comprising:
a chamber including an opening and a cavity defined therein, with the opening disposed above the cavity;
a burner disposed in cavity;
a lid pivotally connected to the chamber and positionable in first and second pivotal positions, with the opening and the cavity not exposed and capped by the lid when the lid is in the first position, with the opening and the cavity exposed and not caped by the lid when the lid in the second position;
first and second legs, with the first leg pivotally connected to the chamber, with the second leg pivotally connected to the first leg;
wherein the grill device has two standing configurations on a surface, with the grill device configured in a first standing configuration including the first leg including an engaging section defined thereon disengaged from a lock protruded from the lid and capable of abutting against the surface and including the second leg including an abutting section defined thereon capable of abutting against the surface and a hooking section defined thereon engaged with a catch protruded from the chamber and including the first and second legs having an obtuse included angle defined therebetween and determining a distance between the engaging and abutting sections, with the grill device configured in the second standing configuration including the first leg including the engaging section engaged with the lock and including the second leg including the abutting section capable of abutting against the surface and the hooking section disengaged from the catch and engaged with the lock and including first and second axes having an acute included angle defined therebetween and determining an angle that the chamber and the lid tilt with respect to the second leg, with the first axis defining a direction the second leg is oriented, with the second axis defining a direction the chamber and the lid are oriented, with a center of gravity of the grill device disposed between the first and second axes.

2. The grill device as claimed in claim 1, wherein the first leg includes first and second distal ends and extends from the first distal end to the second distal end in a first direction, wherein the second leg includes first and second distal ends and extends from the first distal end to the second distal end in a second direction intercrossing the first direction.

3. The grill device as claimed in claim 2, wherein the first leg includes the first distal end including the engaging section defined thereon and the second distal end including a connecting section defined thereon, wherein the second leg includes the first distal end including the abutting section defined thereon and the second distal end including the hooking section defined thereon.

4. The grill device as claimed in claim 1, wherein the lid includes a handle protruded therefrom and capable of being grasped, and wherein the handle includes the lock disposed thereon.

5. The grill device as claimed in claim 4, wherein the handle includes a holding element protruded therefrom, wherein the grill device configured in the second standing configuration includes the lock including a length holding the handle, the engaging section of the first leg, and the hooking section of the second leg together, with the lock including an end fastened to the holding element.

6. The grill device as claimed in claim 1 further comprising a latch protruded from one of the chamber and the lid and an hook protruded from the other of the chamber and the lid and including a notch defined therein, wherein the latch is selectively engagable in the notch, wherein the lid positioned in the first position includes the latch engaged in the notch.

7. The grill device as claimed in claim 2, wherein the first leg includes a first joining section defined thereon and located between the first and second distal ends, wherein the second leg includes a second joining section defined thereon and located between the first and second distal ends, wherein first and second legs are interconnected pivotally and include a pivot engaged therebetween, with the first joining section pivotable about the pivot, with the second joining section pivotal about the pivot.

8. The grill device as claimed in claim 2, wherein the each of first and second joining sections is in the form of an aperture.

9. The grill device as claimed in claim 3, wherein the chamber includes two first lugs and the lid includes two second lugs protruded therefrom respectively, wherein one of the two first lugs and one of the two second lugs are interconnected pivotally and include one of two pintles engaged therebetween, with each first lug pivotal about the pintle engaged therewith, with each second lug pivotal about the pintle engaged therewith.

10. The grill device as claimed in claim 9, wherein the first leg has a U-shape configuration and includes the connecting section defining two connecting ends, with each connecting end including one of the two pintles engaged therewith, wherein each connecting end includes an orifice defined therein, with the pintle engaged therewith including an end received in the orifice.

11. The grill device as claimed in claim 3, wherein the second leg has a configuration including two lateral extensions separated from each other and extending from the abutting section to the hooking section.

12. The grill device as claimed in claim 7, wherein the abutting section, the hooking section and the two lateral extensions extend in a same plane.

13. The grill device as claimed in claim 1 further comprising a cooking plate forming a cooking surface capable of being positioned above the burner, wherein the cooking plate has a configuration including a plurality of rods collectively form the cooking surface and at least one of the rods including a foot protruded therefrom and having a depth to the cooking surface, wherein one of the plurality of rods includes a distal end including a joining end defined thereon, wherein the chamber includes a bracket disposed in the cavity and including a slot defined therein, wherein the cooking plate positioned above the burner includes the joining end engaged in the slot.

14. The grill device as claimed in claim 1 further comprising a gas adaptor and a gas pipe, with the gas adaptor protruded from the chamber and disposed outside the cavity of the chamber, with the gas pipe fludially connecting the gas adaptor to the burner, wherein the grill device is capable of engaging with a gas supply, with the grill device engaged with the gas supply including the gas adaptor engaging with the gas supply.

15. The grill device as claimed in claim 1 further comprising a burner igniter disposed in the cavity of the chamber.

16. The grill device as claimed in claim 1 further comprising a drip pan engaged with the chamber, with the drip pan disposed outside the cavity of the chamber.
